(19) United States
(12) Patent Application Publication
(10) Pub. No.: US 2001/0032542 A1
(43) Pub. Date: Oct. 25, 2001

(54) Turning device

(76) Inventor: Risto Heikkila, Oulainen (FI)

Correspondence Address: Pillsbury Winthrop LLP, Intellectual Property Group, East Tower, Ninth Floor, 1100 New York Avenue, N.W., Washington, DC, 20005-3918, US

(21) Appl. No.: 09/836,330

(22) Filed: Apr. 18, 2001

(30) Foreign Application Priority Data
Apr. 19, 2000 (FI) 20000943

(51) Int. Cl. F15B 11/00

(52) U.S. Cl. 91/508

(57) ABSTRACT

The present invention relates to a turning device for providing a rotational movement in a work machine so as to turn the work machine (8) quickly and smoothly. The turning device comprises a frame (1) in which is arranged at least one control rim (4) turning about the axis of rotation (6). To the control rim is arranged a swiveling axle (5) that projects substantially perpendicularly from the control rim, two pressure-medium-operated actuators (9, 10) at an angle with respect to one another are in turn arranged in the swiveling axle for turning the control rim about the axis of rotation. The actuators are double-acting actuators, whereby independent shuttle valves (28, 29) in the pressure line pairs (24, 25, 26, 27) applied to the actuator are arranged to regulate the pressure medium flow controlling the operation of the actuators.

### FIELD OF THE INVENTION

The present invention relates to a turning device according to the preamble of claim 1. This device is intended for quick and smooth turning of an implement connected to the turning device. In particular, the device is suitable for turning a loader of a forest machine.

### BACKGROUND OF THE INVENTION

Previously known are turning devices for turning a loader, which are based either on mechanical solutions which involve structures that are extremely complicated and liable to breakage, or on hydraulic solutions. However, these known hydraulic turning devices have somewhat limited swivel path, which clearly impedes the use of the turning device and the loader connected thereto.

The most conventional turning device comprises a geared device provided with four hydraulic cylinders in order to provide a sufficient turning movement. However, gear rings or gear racks used in the turning device break easily, which causes a need to repair the work machine utilizing the turning device, and at the same time, prevents continuous working. This turning device structure is also very complicated and expensive to manufacture.

Because known turning devices based on gear rings and gear racks require continuous lubricating in order to operate reliably, they produce detrimental stress to the environment as lubricating oils end up in the soil.

In addition to the turning mechanism the known solutions also require a separate parking brake, e.g. disc brake, for stopping and keeping the device in a desired working position.

### BRIEF DESCRIPTION OF THE INVENTION

The object of the present invention is to provide a novel and more economical turning device than previously, by which the implement connected to said device can be turned quickly and smoothly to any desired position.

This is achieved by a turning device of the invention having characteristics defined in the claims. To put it more precisely, the present invention is mainly characterized by what is disclosed in the characterizing part of claim 1.

Considerable advantages are achieved by the device according to the invention. The device has a simple structure and it is simple to use. The structure of the device is low, and by an actuator arranged in the turning device according to the invention it is possible to turn a turning rim in the device and a loader or another implement connected thereto to any position about the vertical axis of the turning device. Unlike in known devices, the loader or the like of the forest machine can be turned a full circle or even more about the vertical axis of the turning device. The movement of the turning device is thus unlimited both in clockwise and in anti-clockwise directions.

Thanks to its simple structure, the turning device is extremely durable. This allows to avoid unnecessary downtime of the work machine provided with the turning device, and enables efficient working. In addition, the simple structure does not require heavy lubricating as the known solutions, whereby the turning device according to the invention allows to reduce detrimental environmental effects considerably.

The turning device according to the present invention does not require a separate braking device to serve as a parking brake. To keep the device in the working position is possible by means of actuating means of the device by simply blocking pressure medium flow of the actuating means.

### BRIEF DESCRIPTION OF THE DRAWINGS

In the following, the invention will be described in greater detail, with reference to the attached drawing illustrating one preferred embodiment of the invention, in which drawing

FIG. 1 shows a turning device and an implement connected thereto;

FIG. 2 is a top view of the turning device partly cut open;

FIG. 3 shows the turning device of FIG. 2 partly cut open along the line A-A of FIG. 2;

FIG. 4 shows a second embodiment of the turning device of FIG. 2 partly cut open along the line A-A of FIG. 2;

FIG. 5 shows a preferred embodiment of control arrangement of the actuators according to the invention;

FIG. 6 shows a second preferred embodiment of the control arrangement of the turning device actuators;

FIG. 7 shows a third preferred embodiment of the control arrangement of the turning device actuators.

### DETAILED DESCRIPTION OF THE INVENTION

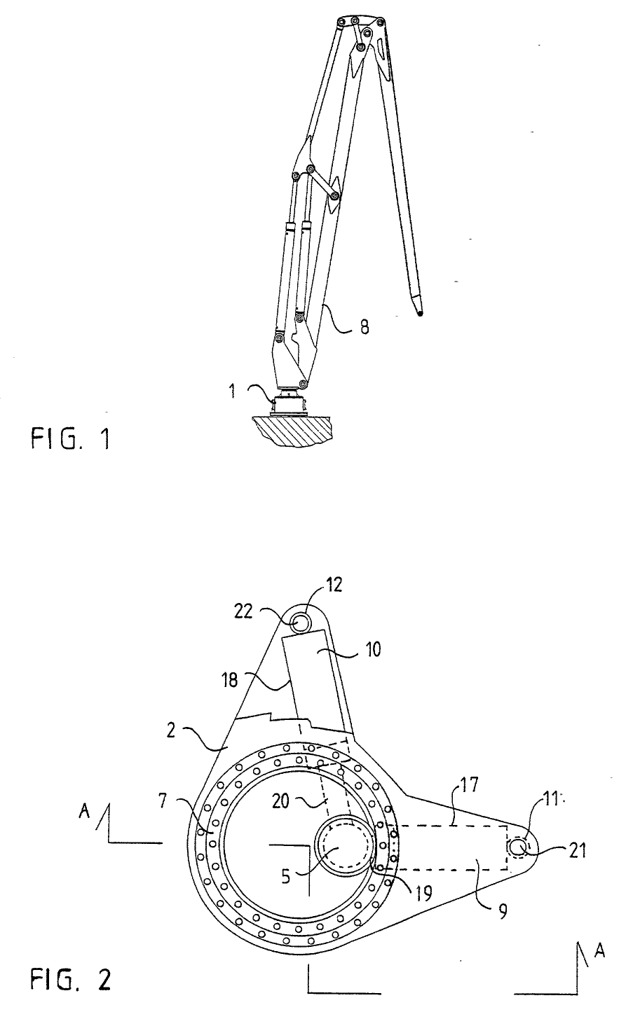

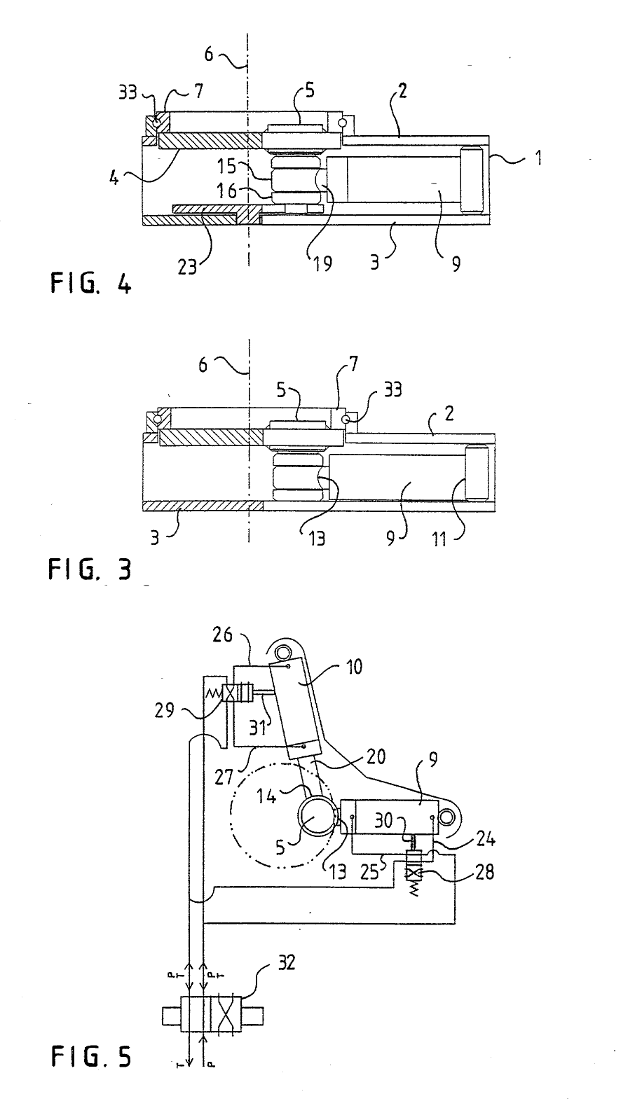

A turning device according to a preferred embodiment appears from FIGS. 2 and 3. The structure of the turning device is described here below, and the reference numerals refer to those appearing in the figures. The turning device of this kind comprises a frame 1 which preferably encompasses the major part of other structural components of the device. FIG. 3 shows substantially parallel top and bottom plates 2 and 3 of the frame. A control rim 4, to which is arranged a swiveling axle 5, is mounted rotatably on bearings with the top plate of the frame. The control rim is arranged to rotate in working position by the effect of transmission power exerted on the swiveling axle about a substantially vertical axis of rotation 6. Thus, a turning movement about the axis of rotation is produced in a securing rim 7 that is arranged in the control rim, in which securing rim is further rigidly arranged an implement 8, such as a loader, as in FIG. 1.

The transmission power exerted on the control rim 4 is generated by two actuators 9 and 10 that are at an angle with respect to one another and connected to the swiveling axle 5. These actuators are turnably arranged with respect to the frame 1 of the turning device, their first ends 11 and 12 being connected to the frame 1 in a pivotable manner and their second ends 13 and 14 being rotatably connected to the swiveling axle. Thus, the second end of the first actuator 9 advantageously comprises a connecting means 15 which encompasses the whole swiveling axle and is linked with bearings thereto, and a connecting means 16 in the second end of the second actuator 10 is arranged such that it is mounted on bearings and advantageously surrounds the swiveling axle in a fork-like manner on either side of the connecting means of the first actuator. Alternatively, the swiveling axle can be arranged in the control rim in a swiveling manner, whereby the second ends of the actuators can be substantially rigidly connected to the swiveling axle. The above-described structure allows to place the actuators on the same sectional plane, which allows to provide most advantageous, low and compact structure of the turning device.

The actuators advantageously comprise conventional pressure medium devices known per se, advantageously two hydraulic cylinders. However, it is possible to think that the actuator also comprises cylinders operated on compressed air or devices driven by electricity, such as spindle motors. The actuator comprises a piston 19 and 20 or a similar member moving with respect to a frame part 17 and 18, the outer end of the member being connected to the swiveling axle 5 by means of connecting means 15 or 16, the first end of the actuator being, in turn, rotatably connected to a link axle 21 or 22 in the frame.

When the turning device is intended for particularly heavy duty, it is also possible to arrange in the frame a lower control rim 23 which rotates with respect thereto as in FIG. 4. By arranging the control rims 4 and 23 such that they are concentric and substantially parallel, they can be inter-connected by the swiveling axle 5. This solution considerably reduces the torque exerted on the control rims and the frame of the turning device, and thus provides improved durability of the device.

The actuators 9 and 10 used being preferably double-acting hydraulic cylinders, they are controlled in a manner known per se by means of pressure lines 24-27 which supply pressure medium to cylinder chambers and which are arranged at the opposite ends of the frame parts 17 and 18, i.e. cylinder tubes. Shuttle valves 28 and 29 are arranged to regulate the pressure medium flow into the chambers, the shuttle valves receiving a control signal from control means 30 and 31 sensing the movements of the actuator and/or the control rim 4 arranged thereto. This double-acting actuator provides more working power than conventional single-acting actuators. Conventional directional control valves and shuttle valves comprise separate components connected to tank and pressure source lines and have different pressure resistance, whereas the present shuttle valve comprises components having substantially equal pressure resistance. Therefore, each line of the shuttle valve is connectable both to the pressure line arriving from the pressure source and to the pressure line leading to the tank.

The turning device operates in the following manner. According to FIG. 2, a piston 20 of the actuator 10 is withdrawn inside the actuator, while a piston 19 of the actuator 9 projects out, and thus the actuators steer the swivel axle 5 arranged in the control rim 4 upwardly in the situation of the figure, i.e. they make the control rim rotate anti-clockwise. This rotation movement can be continued, until the actuator 10 reaches a dead point, in the case of the figure, until the swivel axle connected to the piston has revolved to a position that is substantially closest to the actuator. In this phase of the movement the control arrangement controlling the actuators is arranged to change the flow direction of the pressure medium flowing into the actuator 10 as the piston 20 starts emerging from the frame part 18 of the actuator, while the actuator 9 proceeds with its movement as before. Thus, the transmission power exerted on the swiveling axle continues the anti-clockwise rotation of the control rim, until the swiveling axle reaches the substantially most distant point to the actuator 9. In this phase of the movement, the actuator 9 has reached its other dead point, and the control arrangement controlling the actuators is arranged to change the flow direction of the pressure medium flowing into the actuator 9 such that the piston 19 is withdrawn in the frame part 17 of the actuator, while the actuator 10 proceeds with its movement as before. The revolving movement produced by the actuator 10 stops, in turn, when the actuator reaches its other dead point in accordance with the figure, when the swiveling axle reaches substantially the most distant point to the actuator 10.

The control arrangement is thus arranged to change the flow direction of the pressure medium flowing into the actuator 10 such that the piston 20 is withdrawn into the frame part 18 and the actuator 9 proceeds with its movement as before. The control rim reaches a full 360° swing angle as the swiveling axle reaches the second dead point substantially most closely to the frame part of the actuator. Again, the control arrangement of the turning device is arranged to change the flow direction of the pressure medium flowing into the actuator 9 such that the piston 19 emerges from the frame part 17, while the actuator 10 proceeds with its movement as before.

The actuators 9 and 10, which turn the control rim 4 of the turning device, are thus always pressurized, as the flow direction of the pressure that controls their operation changes during a continuous movement in the extreme positions of the pistons 19 and 20, i.e. at the dead point of each piston movement. It is arranged such that the specific shuttle valves 28 and 29 of the actuator always perform the change of direction. The swiveling direction of the turning device, in turn, is to be selected by means of a main control valve 32 arranged in the control system. A conventional, directional control valve is advantageously used as said valve.

This main control valve 32 can also be closed such that the actuators 9, 10 keep the turning device stationary. Hence, the turning device does not require any separate braking device, but the present, simple construction also provides parking brake function.

As the actuators are arranged in the turning device at an angle with respect to one another, they change working directions at different times, which allows to provide smooth, even movement. The actuators positioned in this manner also tend to keep the torque of the rotary motion exerted on the turning device as constant as possible. The actuators being arranged, according to the present embodiment, at about 90° angle with respect to one another, the torque of one actuator at its dead point is lowest, while that of the other actuator is highest, and consequently this kind of actuator positioning allows to provide an optimally even torque during the entire turning movement. Stresses on actuators resulting from push force at the dead point of their movement are arranged to be received by bearings 33 between the control rim and the securing rim 7 connected thereto and the frame 1 of the turning device. The same bearing is also arranged to receive the torque caused by torsion between the implement 8 connected to the securing rim and the turning device.

FIGS. 5 to 7 show the preferred embodiments of flow diagrams of the actuators. The actuators 9 and 10 of the turning device are controlled by means of pressure lines 24-27 arranged at the opposite ends of the frame parts 17 and 18. These pressure lines are connected in parallel to two working pressure lines 34 and 35 arriving from the main control valve 32. The main control valve communicates in a manner known per se with the tank and the pressure source (not shown). A pressurized working pressure line is selected by the main control valve. The direction of rotation of the turning machine and the work machine connected thereto is changed by the effect of said working pressure line. The working pressure between the pressure lines branching from the working pressure lines and applied in pairs to each actuator can be regulated actuator-specifically by a pressure regulating valve (not shown) arranged between the pressure line pairs 24 and 25 or 26 and 27. In this manner, it is possible to release excess pressure in the pressure lines into a pressure line having lower pressure.

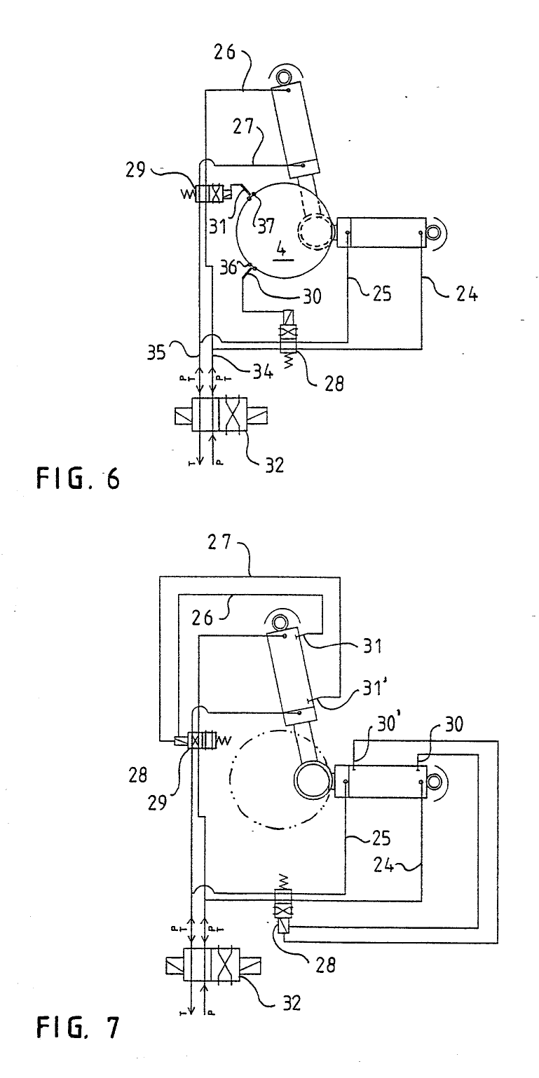

Mutually independent, mechanically or electrically controllable shuttle valves 28 and 29 are arranged in the pressure line pairs 24 and 25 or 26 and 27 for regulating the pressure medium flowing into the chambers of the actuators 9 and 10. These shuttle valves receive their control signals from the control means 30 and 31 that sense the movements of the actuator and/or the control rim 4 connected thereto. Thus, it is arranged that the control signal is obtained by means of a mechanical or inductive control means, indirectly from the lateral movement of the actuator caused by the rotary motion of the actuator and having the same length as the torsion arm at the end on the swiveling axle 5 side, as in FIG. 5, or directly from the movements of the control rim 4 of the turning device, as in FIG. 6, or directly from the extreme positions of the actuator piston, as in FIG. 7.

These control means 30 and 31 include e.g. mechanical sensors according to FIG. 5. In connection with the frame part 17 and 19 of the actuator is arranged a protruding breaker, which is arranged to communicate with a response (not shown) arranged stationary with respect to the frame 1 of the turning device, at least at the dead point of the actuator movement. By arranging the extreme ends of the piston movement at the dead points of the actuator it is possible to make the control means produce a control signal to be transmitted to the shuttle valves, on the basis of which control signal the flow direction of the pressure medium is arranged to change. Thus, the pressure medium flowing into one actuator chamber is arranged to flow into a chamber at the other end of the actuator.

Control according to FIG. 5 is also provided by arranging the control means 30 and 31 stationary with respect to the frame 1 such that it is connected to the housing of the actuator.

Likewise, the embodiment of FIG. 6 comprises a mechanical control means 30 and 31. For instance, two mechanical or electromagnetic sensors are then arranged on the path of the outer periphery of the control rim, the sensors communicating with a response 36 and 37 arranged at the outer periphery. This arrangement conveys a signal to the control arrangement on each actuator dead point. On the basis of the received signal the shuttle valves can be regulated so as to provide a continuous motion.

In the embodiment of FIG. 7, electromagnetic sensors 30 and 30′ as well as 31 and 31′, which serve as control means, are arranged in the actuators 9 and 10 at either end of the actuator frame part. The sensors can be placed both on the housing of the actuator and in the piston 19 and 20 or piston rod of the actuator. These sensors are arranged to operate as the piston rod movement is largest or smallest, controlling the operation of the shuttle valve and providing unlimited rotating movement of the control rim.

The continuous movement of the actuators thus provides smooth rotation of the control rim 4 and the securing rim 7 connected thereto. It should be noted that this rotational movement is completely unlimited, and the rotational movement can be continued as long as desired. Also, the direction of the rotational movement can be readily reversed by the main control valve 32, and it is unlimited both clockwise and anti-clockwise.

The reversing function of the shuttle valves 28 and 29 controlling the pressure medium flow in the actuators 9 and 10 is fully independent of the operation of the main control valve controlling the direction of rotation of the turning device. The control arrangement controls the shuttle valves such that they always change the flow direction of the pressure medium for changing the travel direction of the actuator actuator-specifically, the control rim rotating in semi-circles, even though the main control valve keeps the turning device performing a rotating movement continuously in the same direction.

It should be understood that the above description and the drawings relating thereto are only intended to illustrate the present device. Thus, the construction of the turning device is not restricted to what is set forth in the above nor to the embodiment defined in the claims, but it is obvious to the person skilled in the art that the device can be varied and modified in a variety of ways within the inventive idea disclosed in the attached claims.

The present control arrangement also allows to control actuators in a so called hub motor, which are used for wheel transmission in forest machines, for instance. A hub motor is thus provided, which comprises a minimal number of actuators, and at the same time, the motor has a low structure and comprises few components. Naturally, the motor of this type is very durable and reliable in use.

1. A turning device comprising two pressure-medium-operated, double-acting actuators that are at an angle with respect to one another comprising a piston surrounded by a frame part, the piston being arranged to divide a cavity surrounded by the frame part into two chambers, and the piston comprising a piston rod protruding from the frame part for providing pushing and drawing motions, whereby pressure lines connected in parallel are arranged in pairs in the actuators for arranging pressure medium flow in the chambers, independent shuttle valves in the pressure line pairs are arranged to regulate the direction of the flow such that the shuttle valves are arranged to control the actuators on the basis of a control signal generated at the ends of the actuator movements, wherein the turning device, arranged to provide a rotational movement in an implement comprising a loader arranged substantially rigidly thereto, comprises a frame whereto is rotatably arranged at least one control rim rotating about an axis of rotation and receiving the loader, whereby a substantially upright swiveling axle is arranged in the control rim, to which swiveling axle are rotatably arranged the actuators that are mutually at an angle and substantially on the same sectional plane and that are controlled by the shuttle valves for turning the control rim and the loader by a continuous movement.

2. The turning device as claimed in claim 1, wherein the control signal to be conveyed to the shuttle valves is provided by the control means which have a direct connection to the actuator or a part thereof and are arranged to detect the location of the actuator or the part thereof while it is at an essentially extreme position of its movement.

3. The turning device as claimed in claim 2, wherein the movement of the actuator or a part thereof is arranged to produce a mechanical movement in the sensor constituting the control means for providing a control signal to be applied to the shuttle valves.

4. The turning device as claimed in claim 3, wherein the control means comprises a sensor arranged between the actuator and a frame part projecting to the immediate vicinity of the actuator or a part arranged stationary with respect to the frame at an essentially extreme position of the actuator movement.

5. The turning device as claimed in claim 4, wherein the control means comprises a breaker protruding from the housing of the frame part of the actuator.

6. The turning device as claimed in claim 3, wherein the control means comprises at least one electromagnetic sensor arranged in the actuator in order to monitor the actuator piston movements and to convey information to the control arrangement of the turning device on the piston reaching essentially the extreme positions.

7. The turning device as claimed in claim 2, wherein the control signal applied to the shuttle valves is produced by at least one electromagnetic sensor acting as the control means.

8. The turning device as claimed in claim 7, wherein the control means comprises a sensor arranged between the actuator and a frame part projecting to the immediate vicinity of the actuator or a part arranged stationary with respect to the frame at an essentially extreme position of the actuator movement.

9. The turning device as claimed in claim 8, wherein the control means comprises a breaker protruding from the housing of the frame part of the actuator.

10. The turning device as claimed in claim 7, wherein the control means comprises at least one electromagnetic sensor arranged in the actuator in order to monitor the actuator piston movements and to convey information to the control arrangement of the turning device on the piston reaching essentially the extreme positions.

11. The turning device as claimed in claim 3, wherein the actuators are hydraulic cylinders.

12. A turning device comprising two pressure-medium-operated, double-acting actuators that are at an angle with respect to one another comprising a piston surrounded by a frame part, the piston being arranged to divide a cavity surrounded by the frame part into two chambers, and the piston comprising a piston rod protruding from the frame part for providing pushing and drawing motions, whereby pressure lines connected in parallel are arranged in pairs in the actuators for arranging pressure medium flow in the chambers, independent shuttle valves in the pressure line pairs are arranged to regulate the direction of the flow such that the shuttle valves are arranged to control the actuators on the basis of a control signal generated at the ends of the actuator movements, wherein the turning device, arranged to provide a rotational movement in a implement comprising a loader arranged substantially rigidly thereto, comprises a frame whereto is rotatably arranged two substantially parallel control rims such that the control rims are rotatably about an axis of rotation and concentrically arranged in the frame the uppermost control rim receiving the loader, and that the movements of the control rims are substantially rigidly interconnected by the swiveling axle connecting the control rims, to which swiveling axle are rotatably arranged the actuators that are mutually at an angle and substantially on the same sectional plane and that are controlled by the shuttle valves for turning the control rim and the loader by a continuous movement.

13. The turning device as claimed in claim 12, wherein the control signal to be conveyed to the shuttle valves is provided by the control means which have a direct connection to the actuator or a part thereof and are arranged to detect the location of the actuator or the part thereof while it is at an essentially extreme position of its movement.

14. The turning device as claimed in claim 13, wherein the movement of the actuator or a part thereof is arranged to produce a mechanical movement in the sensor constituting the control means for providing a control signal to be applied to the shuttle valves.

15. The turning device as claimed in claim 14, wherein the control means comprises a sensor arranged between the actuator and a frame part projecting to the immediate vicinity of the actuator or a part arranged stationary with respect to the frame at an essentially extreme position of the actuator movement.

16. The turning device as claimed in claim 15, wherein the control means comprises a breaker protruding from the housing of the frame part of the actuator.

17. The turning device as claimed in claim 14, wherein the control means comprises at least one electromagnetic sensor arranged in the actuator in order to monitor the actuator piston movements and to convey information to the control arrangement of the turning device on the piston reaching essentially the extreme positions.

18. The turning device as claimed in claim 13, wherein the control signal applied to the shuttle valves is produced by at least one electromagnetic sensor acting as the control means.

19. The turning device as claimed in claim 18, wherein the control means comprises a sensor arranged between the actuator and a frame part projecting to the immediate vicinity of the actuator or a part arranged stationary with respect to the frame at an essentially extreme position of the actuator movement.

20. The turning device as claimed in claim 19, wherein the control means comprises a breaker protruding from the housing of the frame part of the actuator.

21. The turning device as claimed in claim 18, wherein the control means comprises at least one electromagnetic sensor arranged in the actuator in order to monitor the actuator piston movements and to convey information to the control arrangement of the turning device on the piston reaching essentially the extreme positions.

22. The turning device as claimed in claim 14, wherein the actuators are hydraulic cylinders.
